(19) United States
(12) Patent Application Publication
(10) Pub. No.: US 2026/0259132 A1
(43) Pub. Date: Sep. 3, 2026

(54) SYSTEM AND METHODS FOR IMPROVED SAMPLE IMAGING

(71) Applicant: VERACIO LTD., Salt Lake City, UT (US)

(72) Inventors: Luke George, Sefton Park (AU); Sasa Krneta, Adelaide (AU)

(21) Appl. No.: 18/877,712

(22) PCT Filed: Jun. 15, 2023
(86) PCT No.: PCT/US2023/025388

§ 371 Date: Dec. 20, 2024

Related U.S. Application Data
(60) Provisional application No. 63/354,966, filed on Jun. 23, 2022.

(51) Int. Cl. G01N 21/27

(52) U.S. Cl. CPC G01N 21/27; G01N 2201/1293; G01N 2201/1296

(57) ABSTRACT

Provided herein are methods and systems for improved sample imaging. An input image of a sample may be aligned with at least one hyperspectral image of a portion of the sample. Once aligned, the input image and the at least one hyperspectral image may be provided to at least one machine learning model to generate a calibration matrix. The calibration matrix may be applied to the input image to generate a false color mineral map. The false color mineral map may be indicative of a plurality of minerals associated with the sample. Additionally, the false color mineral map may comprise a size that is much smaller than a false color mineral map generated using a hyperspectral image(s) of the entire sample.

### CROSS-REFERENCE TO RELATED PATENT APPLICATION

This application claims priority to U.S. Provisional Application No. 63/354,966, filed on Jun. 23, 2022, which is incorporated by reference in its entirety herein.

### BACKGROUND

Hyperspectral imaging is a method of capturing various wavelengths of electromagnetic rays. A hyperspectral image of a sample may be indicative of various minerals within the sample. Due to the nature of hyperspectral imaging, hyperspectral images of entire samples are very large in size and therefore require extensive storage and computational requirements. These and other considerations are discussed herein.

### SUMMARY

It is to be understood that both the following general description and the following detailed description are exemplary and explanatory only and are not restrictive. Provided herein are methods and systems for improved sample imaging. In one example, an input image of a sample comprising a plurality of minerals may be aligned with at least one hyperspectral image depicting a portion of the sample. Once aligned, the input image and the at least one hyperspectral image may be provided to at least one machine learning model to generate a calibration matrix.

The at least one machine learning model may comprise a trained convolutional neural network. The trained convolutional neural network may generate the calibration matrix based on the input image aligned with the at least one hyperspectral image. The input image may be a two-dimensional red-green-blue (RGB) image of the sample. The calibration matrix may be applied to the two-dimensional RGB image of the sample to generate a false color mineral map. The false color mineral map may be indicative of the plurality of minerals.

False color mineral maps generated according to the present methods and systems improve upon those that may be generated by existing methods and systems. For example, unlike existing methods and systems that require a hyperspectral image(s) of an entire sample to generate a false color mineral map, the present methods and systems may generate a false color mineral map based on at least one hyperspectral image depicting a portion of the sample and a two-dimensional RGB image of the sample. As a result, the false color mineral maps generated according to the present methods and systems require less data to be generated (e.g., less hyperspectral data) and require less space for storage due to their smaller size. As a result, the methods and systems described herein may reduce computational resources and/or network resources required to process, send, receive, and/or store images of samples while including sufficient data relating to the samples (e.g., materials, minerals, composition, etc.) that may be necessary for proper sample analysis (e.g., excavation, exploration, etc.).

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of the present description serve to explain the principles of the methods and systems described herein:

FIG. 1 shows an example system;

FIG. 2 shows an example system;

FIG. 3 shows an example input image;

FIG. 4 shows an example system;

FIG. 5 shows an example process flowchart;

FIG. 6 shows example inputs and outputs of a machine learning module;

FIG. 7 shows example inputs and outputs of a computing device;

FIG. 8 shows an example system;

FIG. 9 shows a flowchart for an example method; and

FIG. 10 shows a flowchart for an example method.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. Similarly, when values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memristors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

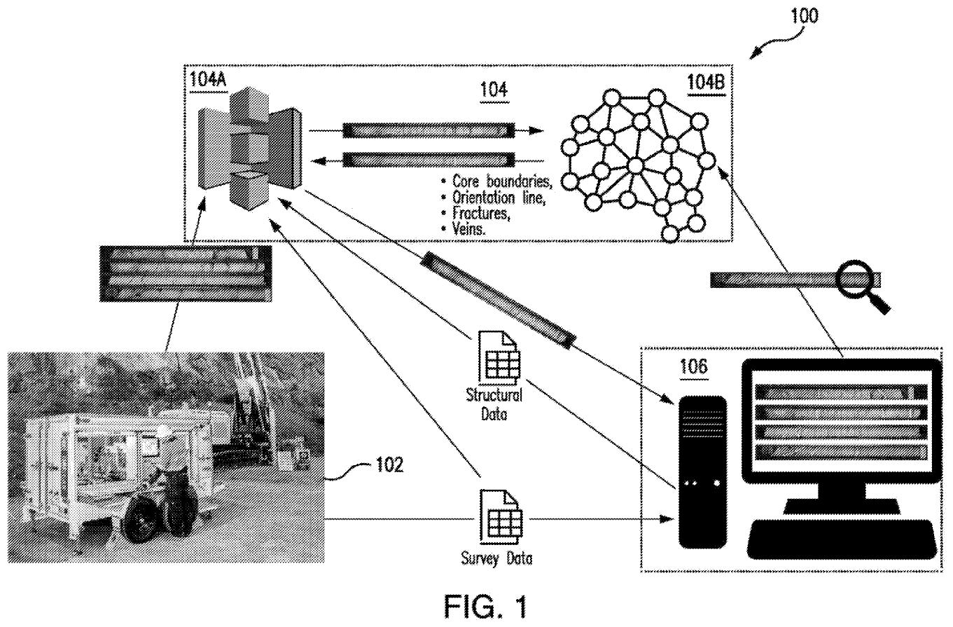

The word “sample” as used herein may refer to one of or more of a piece, a chip, a portion, a mass, a chunk, etc., of a rock(s), a mineral(s), a material(s), a borehole(s), a pit wall(s), or any other organic (or inorganic) matter. For example, a sample may refer to a core sample, a rock sample, a mineral sample, a combination thereof, and/or the like. FIG. 1 shows an example system 100 for improved sample imaging. The system 100 may include a job/excavation site 102 having a computing device(s), such as one or more imaging devices, capable of capturing/generating images of samples. For example, the one or more imaging devices may be configured to capture red-green-blue (RGB) images/data of the samples as well as hyperspectral images/data of the samples. The computing device(s) at the job/excavation site 102 may provide (e.g., upload) such images to a server 104 via a network. The network may facilitate communication between each device/entity of the system 100. The network may be an optical fiber network, a coaxial cable network, a hybrid fiber-coaxial network, a wireless network, a satellite system, a direct broadcast system, an Ethernet network, a high-definition multimedia interface network, a Universal Serial Bus (USB) network, or any combination thereof. Data may be sent/received via the network by any device/entity of the system 100 via a variety of transmission paths, including wireless paths (e.g., satellite paths, Wi-Fi paths, cellular paths, etc.) and terrestrial paths (e.g., wired paths, a direct feed source via a direct line, etc.).

The server 104 may be a single computing device or a plurality of computing devices. As shown in FIG. 1, the server may include a storage module 104A and a machine learning module 104B. The storage module 104A may comprise one or more storage repositories that may be local, remote, cloud-based, a combination thereof, and/or the like. The machine learning module 104B, which is discussed further herein, may be configured to generate a false color mineral map of a sample based on an RGB image(s) of the sample and one or more hyperspectral “spot scans” (e.g., hyperspectral images of a portion(s) of the sample). Such false color mineral maps may be considered derived/artificial hyperspectral images in RGB format, and they may comprise a size that is much smaller than false color mineral maps generated using a complete hyperspectral image of an entire sample. The process for generating false color mineral maps is discussed further herein.

Returning to FIG. 1, the system 100 may also include a computing device 106. The computing device 106 may be in communication with the server 104 and/or the computing device(s) at the job/excavation site 102. Analysis of input images of samples may be facilitated using a web-based or locally-installed application, such as a structural logging application (hereinafter an “application”), executing or otherwise controlled by the computing device 106. The computing device 106 may use the application to determine structural data associated using one or more images of each sample.

The system 100 may receive orientation data, survey data, x-ray fluorescence (XRF) data, exclusion zone data, etc., associated with each sample (collectively, “supplemental data”). The supplemental data may be provided to the system 100 by the user via the computing device 106, by the server 104, or by a third-party computing device (not shown). The orientation data may be indicative of an orientation, a depth, etc., of samples at an extraction point (e.g., a borehole). The orientation data may be indicative of one or more sine waves, strike angles, dip angles, an azimuth, etc. associated with each sample. The XRF data for a sample may be indicative of a plurality of minerals that make up the sample. The exclusion zone data may be indicative of at least one portion of a sample (and/or input image) that is to be excluded from analysis (e.g., due to physical characteristics of the sample, such as fractures, breaks, etc.). The examples above relating to the supplemental data are meant to be exemplary only. The supplemental data may comprise additional information related to the samples as well. The computing device 106 and/or the server 104 may determine a rock-quality designation (RQD) for each sample. The RQD for a sample may be a rough measure of a degree of jointing or fracturing in the sample. The structural data, the supplemental data, the RQD for each sample, etc., may be stored at the server 104 and/or at the computing device 106.

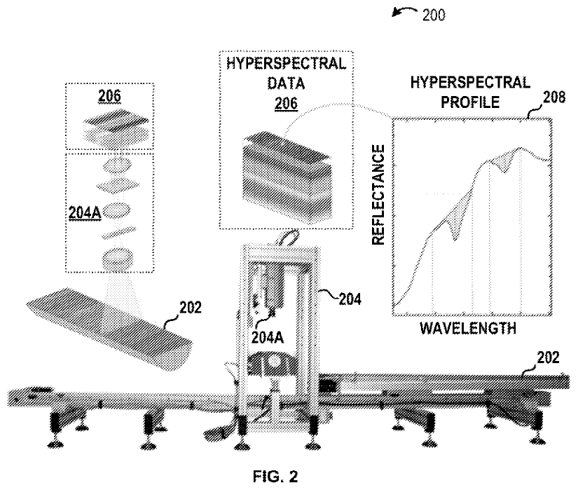

FIG. 2 shows an example system 200. The job/excavation site 102 may comprise one or more components of the system 200. For example, as shown in FIG. 2, the system 200 may comprise a hyperspectral imaging apparatus 204, which may comprise a hyperspectral imaging device(s) 204. The one or more imaging devices at the job/excavation site 102 described herein may comprise the hyperspectral imaging apparatus 204 and/or the hyperspectral imaging device(s) 204A. While RGB images of samples may be well-suited to humans, the visible spectral range of the electromagnetic spectrum contains information beyond the three RGB values generally expected from traditional RGB images. This hyperspectral data includes hyperspectral color information, as well as mineral/material information associated with each sample, based on the spectrum represented in each pixel of a hyperspectral image.

The hyperspectral imaging apparatus 204 may capture such hyperspectral data associated with each sample. For example, as shown in FIG. 2, the hyperspectral imaging device(s) 204A may comprise a series of optical sensors that may capture hyperspectral data 206 associated with a sample 202. The hyperspectral data 206 may be associated with an imaging tray and/or an imaging box that was used when imaging the sample 202. The hyperspectral data 206 for the sample 202 may be indicative of a hyperspectral profile 208 of the sample 202. Note that the sample 202 is shown in FIG. 2 as being a split/open sample for exemplary purposes only. The hyperspectral imaging device(s) 204A may image whole samples as well and capture associated hyperspectral data 206 for each such sample.

The hyperspectral imaging device(s) 204A may capture hyperspectral images of entire samples as well as “spot scans” of samples. A hyperspectral spot scan may comprise a hyperspectral image and/or corresponding hyperspectral data 206 for a portion(s) of the sample rather than the entire sample. Such hyperspectral spot scans may be significantly smaller in size (e.g., data size) compared to a hyperspectral image of an entire sample. As further described herein, the machine learning module 104B, may be configured to generate a false color mineral map of a sample based on an RGB image(s) of the sample and one or more hyperspectral spot scans of the sample (e.g., captured using the hyperspectral imaging device(s) 204A). The RGB image(s) of the sample may be associated with an imaging tray and/or an imaging box that was used when imaging the sample.

False color mineral maps generated according to the methods and systems described herein may comprise a size that is much smaller than false color mineral maps generated according to existing methods and systems. For example, false color mineral maps generated according to existing methods and systems require a complete hyperspectral image of an entire sample. This results in larger-sized false mineral maps as compared to the false color mineral maps generated according to the methods and systems described herein. In contrast to the existing methods and systems, the methods and systems described herein may generate false color mineral maps based on an RGB image(s) of the sample and one or more hyperspectral spot scans of the sample (e.g., less hyperspectral data is required as compared to the existing methods and systems). Therefore, the present methods and systems improve upon the existing methods and systems by requiring less data to generate the false color mineral maps (e.g., by using an RGB image(s) of the sample and one or more hyperspectral spot scans of the sample) and requiring less storage space (e.g., less data) due to their smaller size. As a result, the methods and systems described herein may reduce computational resources and/or network resources required to process, send, receive, and/or store images of samples while including sufficient data relating to the samples (e.g., materials, minerals, composition, etc.) that may be necessary for proper sample analysis (e.g., excavation, exploration, etc.).

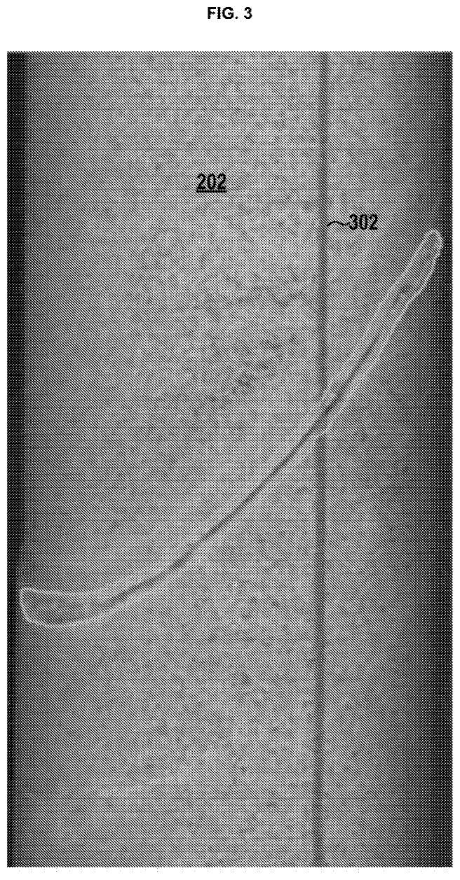

As described herein, the supplemental data associated with each sample may comprise orientation data. The orientation data for a sample may be used to generate a virtual orientation line that may be overlain on images of the samples (e.g., RGB images and/or hyperspectral images). FIG. 3 shows an example partial RBG image of a sample (e.g., the sample 202) with an example virtual orientation line 302. The virtual orientation line 302 may comprise a line formed through an intersection of a vertical plane and an edge of the sample where the vertical plane passes through an axis of the sample. The virtual orientation line 302 may be a line that is parallel to the axis of the sample, representing a bottom most point—or a top most point—of the sample.

As further described herein, an orientation line of a sample, such as the virtual orientation line 302, may assist in generating a false color mineral map of the sample based on a corresponding RGB image(s) of the sample and one or more hyperspectral spot scans of the sample. For example, the orientation line may be used to align the RGB image(s) of the sample with the one or more hyperspectral spot scans of the sample by the machine learning module 104B using a segmentation model and/or algorithm. The aligned RGB image(s) and the one or more hyperspectral spot scans may then be analyzed by the machine learning module 104B to generate a calibration matrix, as further discussed herein, which may be used to generate a false color mineral map of the sample.

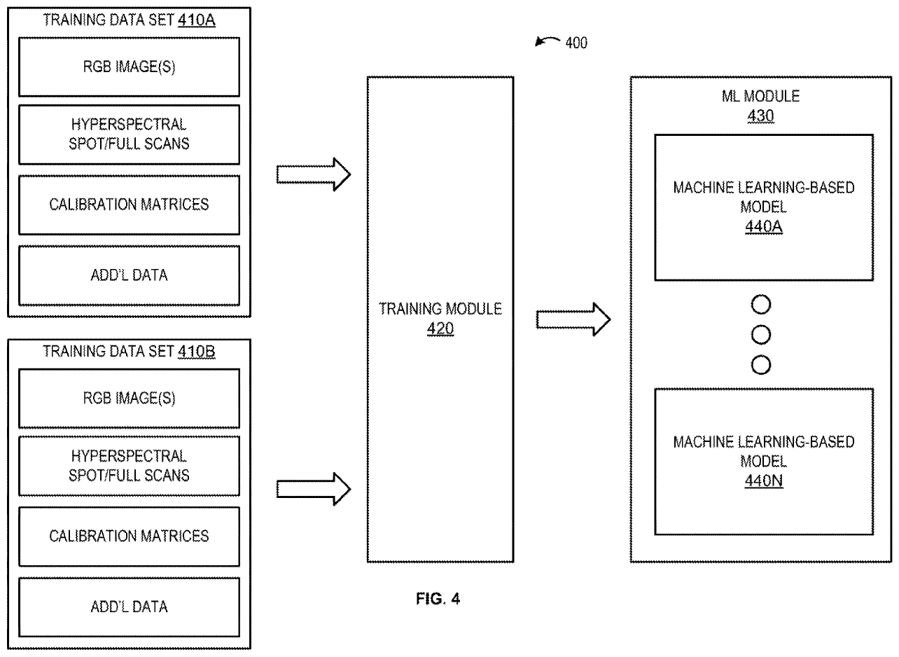

Turning now to FIG. 4, a system 400 for training a machine learning module 430 is shown. The machine learning module 430 may comprise the machine learning module 104B. The machine learning module 430 may be trained by a training module 420 of the system 400 to generate false color mineral maps and associated calibration matrices associated with a number of samples. The training module 420 may use machine learning (“ML”) techniques to train, based on an analysis of one or more training datasets 410, the ML module 430. The training dataset 410 may comprise any number of datasets or subsets 410-410N. For example, the training dataset 410 may comprise a first training dataset 410A and a second training dataset 410B.

The training module 420 may use a supervised, semi-supervised, or unsupervised training method, or a combination thereof, depending on the training dataset 410. For example, the training dataset 410 may comprise, for each sample, input data. The input data may comprise at least one RGB image of the respective sample plus one or more of the following: a hyperspectral spot scan(s) of the respective sample; alignment data relating to an alignment of the at least one RGB image with the hyperspectral spot scan(s); a full hyperspectral scan(s) of the respective sample; alignment data relating to an alignment of the at least one RGB image with the full hyperspectral spot scan(s); a full hyperspectral scan(s) of the respective sample with one or more spot scans indicated; a calibration matrix associated with the respective sample; one or more components of the supplemental data described herein (e.g., orientation data, survey data, XRF data, exclusion zone data, etc.); a false color mineral map(s) associated with the respective sample; a combination thereof, and/or the like. In examples where the training dataset 410 comprises ground truth data for a respective sample, such as an associated calibration matrix or a false color mineral map(s), the training module 420 may use a supervised training method. In examples where the training dataset 410 does not include such ground truth data, the training module 420 may use an un-supervised training method. Other examples, such as for semi-supervised training, are possible as well.

The machine learning module 430 may be trained by the training module 420 to generate false color mineral maps and associated calibration matrices associated with a number of samples. A calibration matrix for a sample may be specific to that particular sample. In other examples, the calibration matrix may be specific to an imaging apparatus that was used to capture the sample's corresponding RGB image(s), hyperspectral spot scan(s), and/or full hyperspectral scan (e.g., the imaging apparatus 204). In still further examples, the calibration matrix may be specific to a particular job/excavation site (e.g., the job/excavation site 102). Other examples are possible as well.

A calibration matrix for a sample may be the result of deep learning performed by the machine learning module 430. For example, the machine learning module 430 (once trained as described herein) may receive as input at least one RGB image of the sample as well as a hyperspectral spot scan(s) of the sample, which may be aligned with the at least one RGB image. The machine learning module 430 may output the calibration matrix based on the input. The calibration matrix may comprise the information needed to generate a false color mineral map (in addition to other outputs) based on the at least one RGB image and the hyperspectral spot scan(s) of the sample. In some examples, the calibration matrix may be indicative of and/or comprise a spectral signature for each mineral within the sample (e.g., based on RGB data from the at least one RGB image) corresponding to the hyperspectral spot scan(s). The spectral signature for each mineral within the sample may be generated by the machine learning module 430 as part of generating the calibration matrix. In some examples, the spectral signature for one or more minerals within the sample may be added to the calibration matrix may a user of a computing device(s) associated with the machine learning module 430 (e.g., user/manual additions of one or more spectral signatures for the one or more minerals). Other examples are possible as well.

The false color mineral map may be generated by a computing device (e.g., the computing device 106) by applying the calibration matrix to the at least one RGB image and the hyperspectral spot scan(s) of the sample. The computing device may, for example, apply the calibration matrix to the at least one RGB image and the hyperspectral spot scan(s) to generate the false color mineral map. Other examples are possible as well.

Returning to FIG. 4, the first training dataset 410A and the second training dataset may each comprise, for each sample used for training, at least one RGB image of the respective sample plus one or more of the following: a hyperspectral spot scan(s) of the respective sample; alignment data relating to an alignment of the at least one RGB image with the hyperspectral spot scan(s); a full hyperspectral scan(s) of the respective sample; alignment data relating to an alignment of the at least one RGB image with the full hyperspectral spot scan(s); a full hyperspectral scan(s) of the respective sample with one or more spot scans indicated; a calibration matrix associated with the respective sample; one or more components of the supplemental data described herein (e.g., orientation data, survey data, XRF data, exclusion zone data, etc.); a false color mineral map(s) associated with the respective sample; a combination thereof, and/or the like.

A subset of one or both of the first training dataset 410A or the second training dataset 410B may be randomly assigned to a testing dataset. In some implementations, the assignment to a testing dataset may not be completely random. In this case, one or more criteria may be used during the assignment. In general, any suitable method may be used to assign data to the testing dataset, while ensuring that the distributions of input data are properly assigned for training and testing purposes.

The training module 420 may train the ML module 430 by extracting a feature set from the training datasets 410 according to one or more feature selection techniques. For example, the training module 420 may train the ML module 430 by extracting a feature set from the training datasets 410 that includes statistically significant features. The training module 420 may extract a feature set from the training datasets 410 in a variety of ways. The training module 420 may perform feature extraction multiple times, each time using a different feature-extraction technique. In an example, the feature sets generated using the different techniques may each be used to generate different machine learning-based models 440A-440N. For example, the feature set with the highest quality metrics may be selected for use in training. The training module 420 may use the feature set(s) to build one or more machine learning-based models 440A-440N, each of which may be the machine learning module 104B or a component/piece thereof.

The training datasets 410 may be analyzed to determine any dependencies, associations, and/or correlations between determined features in unlabeled input data and the features of labeled input data in the training dataset 410. The identified correlations may have the form of a list of features. The term “feature,” as used herein, may refer to any characteristic of an item of data that may be used to determine whether the item of data falls within one or more specific categories. A feature selection technique may comprise one or more feature selection rules. The one or more feature selection rules may comprise a feature occurrence rule. The feature occurrence rule may comprise determining which features in the training dataset 410 occur over a threshold number of times and identifying those features that satisfy the threshold as features.

A single feature selection rule may be applied to select features or multiple feature selection rules may be applied to select features. The feature selection rules may be applied in a cascading fashion, with the feature selection rules being applied in a specific order and applied to the results of the previous rule. For example, the feature occurrence rule may be applied to the training datasets 410 to generate a first list of features. A final list of features may be analyzed according to additional feature selection techniques to determine one or more feature groups. Any suitable computational technique may be used to identify the feature groups using any feature selection technique such as filter, wrapper, and/or embedded methods. One or more feature groups may be selected according to a filter method. Filter methods include, for example, Pearson's correlation, linear discriminant analysis, analysis of variance (ANOVA), chi-square, combinations thereof, and the like. The selection of features according to filter methods are independent of any machine learning algorithms. Instead, features may be selected on the basis of scores in various statistical tests for their correlation with the outcome variable.

As another example, one or more feature groups may be selected according to a wrapper method. A wrapper method may be configured to use a subset of features and train the ML module 430 using the subset of features. Based on the inferences drawn from a previous model, features may be added and/or deleted from the subset. Wrapper methods include, for example, forward feature selection, backward feature elimination, recursive feature elimination, combinations thereof, and the like. As an example, forward feature selection may be used to identify one or more feature groups. Forward feature selection is an iterative method that begins with no feature in the corresponding machine learning model. In each iteration, the feature which best improves the model is added until an addition of a new variable does not improve the performance of the machine learning model. As an example, backward elimination may be used to identify one or more feature groups. Backward elimination is an iterative method that begins with all features in the machine learning model. In each iteration, the least significant feature is removed until no improvement is observed on removal of features. Recursive feature elimination may be used to identify one or more feature groups. Recursive feature elimination is a greedy optimization algorithm which aims to find the best performing feature subset. Recursive feature elimination repeatedly creates models and keeps aside the best or the worst performing feature at each iteration. Recursive feature elimination constructs the next model with the features remaining until all the features are exhausted. Recursive feature elimination then ranks the features based on the order of their elimination.

As a further example, one or more feature groups may be selected according to an embedded method. Embedded methods combine the qualities of filter and wrapper methods. Embedded methods include, for example, Least Absolute Shrinkage and Selection Operator (LASSO) and ridge regression which implement penalization functions to reduce overfitting. For example, LASSO regression performs L1 regularization which adds a penalty equivalent to absolute value of the magnitude of coefficients and ridge regression performs L2 regularization which adds a penalty equivalent to square of the magnitude of coefficients.

After the training module 420 has generated a feature set(s), the training module 420 may generate a machine learning-based model 440 based on the feature set(s). A machine learning-based model may refer to a complex mathematical model for data classification that is generated using machine-learning techniques. In one example, the machine learning-based model 440 may include a map of support vectors that represent boundary features. By way of example, boundary features may be selected from, and/or represent the highest-ranked features in, a feature set. The training module 420 may use the feature sets determined or extracted from the training dataset 410 to build the machine learning-based models 440A-440N. In some examples, the machine learning-based models 440A-440N may be combined into a single machine learning-based model 440. Similarly, the ML module 430 may represent a single classifier containing a single or a plurality of machine learning-based models 440 and/or multiple classifiers containing a single or a plurality of machine learning-based models 440.

The features may be combined in a classification model trained using a machine learning approach such as discriminant analysis; decision tree; a nearest neighbor (NN) algorithm (e.g., k-NN models, replicator NN models, etc.); segmentation algorithm; statistical algorithm (e.g., Bayesian networks, etc.); clustering algorithm (e.g., k-means, mean-shift, etc.); neural networks (e.g., reservoir networks, artificial neural networks, etc.); support vector machines (SVMs); logistic regression algorithms; linear regression algorithms; Markov models or chains; principal component analysis (PCA) (e.g., for linear models); multi-layer perceptron (MLP) ANNs (e.g., for non-linear models); replicating reservoir networks (e.g., for non-linear models, typically for time series); random forest classification; a combination thereof and/or the like. The resulting ML module 430 may comprise a decision rule or a mapping for each feature of each sample (and associated RGB and hyperspectral images) in the training datasets 410 that may be used to generate calibration matrices and/or false color mineral maps for other samples. In an embodiment, the training module 420 may train the machine learning-based models 440 as a convolutional neural network (CNN).

Each of the machine learning-based models 440 may comprise a deep-learning model comprising one or more portions of the CNN. The CNN may perform feature extraction on RGB images, hyperspectral spot scans, full hyperspectral scans/images, etc., using a set of convolutional operations, which may comprise is a series of filters that are used to filter each image. The CNN may perform a number of convolutional operations (e.g., feature extraction operations).

The CNN may comprise a plurality of blocks that may each comprise a number of operations performed on an input image (e.g., an RGB image, hyperspectral spot scan, full hyperspectral scan/image, etc.). The operations performed on the input image may include, for example, a Convolution2D (Conv2D) or SeparableConvolution2D operation followed by zero or more operations (e.g., Pooling, Dropout, Activation, Normalization, BatchNormalization, other operations, or a combination thereof), until another convolutional layer, a Dropout operation, a Flatten Operation, a Dense layer, or an output of the CNN is reached. A Dense layer may comprise a group of operations or layers starting with a Dense operation (e.g., a fully connected layer) followed by zero or more operations (e.g., Pooling, Dropout, Activation, Normalization, BatchNormalization, other operations, or a combination thereof) until another convolution layer, another Dense layer, or the output of the network is reached. A boundary between feature extraction based on convolutional layers and a feature classification using Dense operations may be indicated by a Flatten operation, which may “flatten” a multidimensional matrix generated using feature extraction techniques into a vector.

The CNN may comprise a plurality of hidden layers, ranging from as few as one hidden layer up to four hidden layers. In some examples, the input image may be preprocessed prior to being provided to the CNN. For example, the input image may be resized to a uniform size. The CNN may comprise a plurality of hyperparameters and at least one activation function at each block. The plurality of hyperparameters may comprise, for example, a batch size, a dropout rate, a number of epochs, a dropout rate, strides, paddings, etc. The at least one activation function may comprise, for example, a rectified linear units activation function or a hyperbolic tangent activation function.

At each block of the plurality of blocks of the CNN, the input image may be processed according to a particular kernel size (e.g., a number of pixels). The input image may be passed through a number of convolution filters at each block of the plurality of blocks, and an output may then be provided. The output may comprise one or more of the following: a calibration matrix, a false color mineral map, a mineralogy report (e.g., indicating materials/minerals comprising the corresponding sample), a mineral map (e.g., indicating locations of the materials/minerals comprising the corresponding sample), an indication of an accuracy of the corresponding calibration matrix and/or false color mineral map (e.g., a confidence level), a combination thereof, and/or the like.

The ML module 430 may use the CNN to generate calibration matrices and/or false color mineral maps for other samples in the testing data set. In one example, the calibration matrix and/or the false color mineral map(s) for each sample may include a confidence level that corresponds to a likelihood or a probability that the false color mineral map is accurate. The confidence level may be a value between zero and one. In general, multiple confidence levels may be provided for each sample in the testing data set.

As described herein, the supplemental data associated with each sample may comprise orientation data. The orientation data may be used to determine an orientation line of a sample, such as the orientation line 202 shown in FIG. 2. A segmentation model may use the orientation line to align an RGB image(s) of the sample with hyperspectral spot scans of the sample. The ML module 430 may comprise the segmentation model. The segmentation model may be trained by applying one or more segmentation algorithms to a plurality of training RGB images and hyperspectral spot scans of samples.

In some cases, segmentation may be based on semantic content of the RGB images and hyperspectral spot scans. For example, segmentation analysis performed on the RGB images and hyperspectral spot scans may indicate a region of the RGB images and hyperspectral spot scans depicting a particular attribute(s) of the corresponding sample. In some cases, segmentation analysis may produce segmentation data. The segmentation data may indicate one or more segmented regions of the analyzed RGB images and hyperspectral spot scans. For example, the segmentation data may include a set of labels, such as pairwise labels (e.g., labels having a value indicating “yes” or “no”) indicating whether a given pixel in the RGB images and/or hyperspectral spot scans is part of a region depicting a particular attribute(s) of the corresponding sample. In some cases, labels may have multiple available values, such as a set of labels indicating whether a given pixel depicts a first attribute, a second attribute, a combination of attributes, and so on. The segmentation data may include numerical data, such as data indicating a probability that a given pixel is a region depicting a particular attribute(s) of the corresponding sample. In some cases, the segmentation data may include additional types of data, such as text, database records, or additional data types, or structures. In the examples discussed herein, the segmentation data may indicate whether each pixel of the RGB images and/or the hyperspectral spot scans is indicative of an attribute(s) of the corresponding sample indicative of an orientation of the sample. The orientation line described herein may be based on such segmentation data.

The segmentation model may classify each pixel of a plurality of pixels of at least one RGB image of the sample as corresponding to or not corresponding to an attribute(s) of the sample indicative of the orientation line of the sample. The segmentation model may also classify each pixel of a plurality of pixels of the corresponding hyperspectral spot scans as corresponding to or not corresponding to the orientation line of the sample. The segmentation model may align the at least one RGB image with the corresponding hyperspectral spot scans —or vice-versa—based on the derived orientation line.

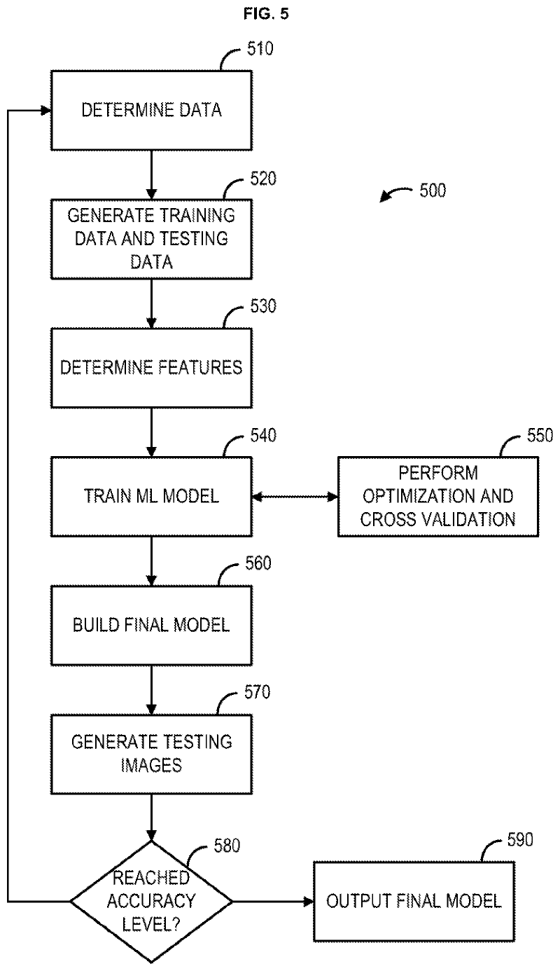

Turning now to FIG. 5, a flowchart illustrating an example training method 500 for generating the ML module 430 using the training module 420 is shown. The training module 420 can implement supervised, unsupervised, and/or semi-supervised (e.g., reinforcement based) machine learning-based models 440. The method 500 illustrated in FIG. 5 is an example of a supervised learning method; variations of this example of training method are discussed below, however, other training methods can be analogously implemented to train unsupervised and/or semi-supervised machine learning models. The training method 500 may determine (e.g., access, receive, retrieve, etc.) data at step 510. The data may comprise any of the following input data: an RGB image(s) of a respective sample, a hyperspectral spot scan(s) of the respective sample; alignment data relating to an alignment of the at least one RGB image with the hyperspectral spot scan(s); a full hyperspectral scan(s) of the respective sample; alignment data relating to an alignment of the at least one RGB image with the full hyperspectral spot scan(s); a full hyperspectral scan(s) of the respective sample with one or more spot scans indicated; a calibration matrix associated with the respective sample; one or more components of the supplemental data described herein (e.g., orientation data, survey data, XRF data, exclusion zone data, etc.); a false color mineral map(s) associated with the respective sample; a combination thereof, and/or the like.

The training method 500 may generate, at step 520, a training dataset and a testing data set. The training dataset and the testing data set may be generated by randomly assigning portions of the input data to either the training dataset or the testing data set. In some implementations, the assignment of input data as training or testing data may not be completely random. The training method 500 may determine (e.g., extract, select, etc.), at step 530, one or more features. As an example, the training method 500 may determine a set of features from the input data. The training method 500 may train one or more machine learning models using the one or more features at step 540. In one example, the machine learning models may be trained using supervised learning. In another example, other machine learning techniques may be employed, including unsupervised learning and semi-supervised. The machine learning models trained at 540 may be selected based on different criteria depending on the problem to be solved and/or data available in the training dataset. For example, machine learning classifiers can suffer from different degrees of bias. Accordingly, more than one machine learning model can be trained at 540, optimized, improved, and cross-validated at step 550.

The training method 500 may select one or more of the machine learning models trained at step 550 to build a final model at 560. The final model may be evaluated using the testing data set. The final model may analyze the testing data set and generate testing calibration matrices and/or false color mineral maps at step 570. The testing calibration matrices and/or false color mineral maps may be evaluated at step 580 to determine whether the testing calibration matrices and/or false color mineral maps meet a desired accuracy level compared to ground calibration matrices and/or false color mineral maps. For example, the testing calibration matrices and/or false color mineral maps may be evaluated against the ground truth calibration matrices and/or false color mineral maps to determine how accurate the testing calibration matrices and/or false color mineral maps are of the actual, ground truth calibration matrices and/or false color mineral maps.

Performance of the final model may be evaluated in a number of ways, as can be appreciated by those skilled in the art. When a desired accuracy level is reached, the final model (e.g., the trained ML module 430) may be output at step 590. When the desired accuracy level is not reached, then a subsequent iteration of the training method 500 may be performed starting at step 510 with variations such as, for example, considering a larger collection of training data.

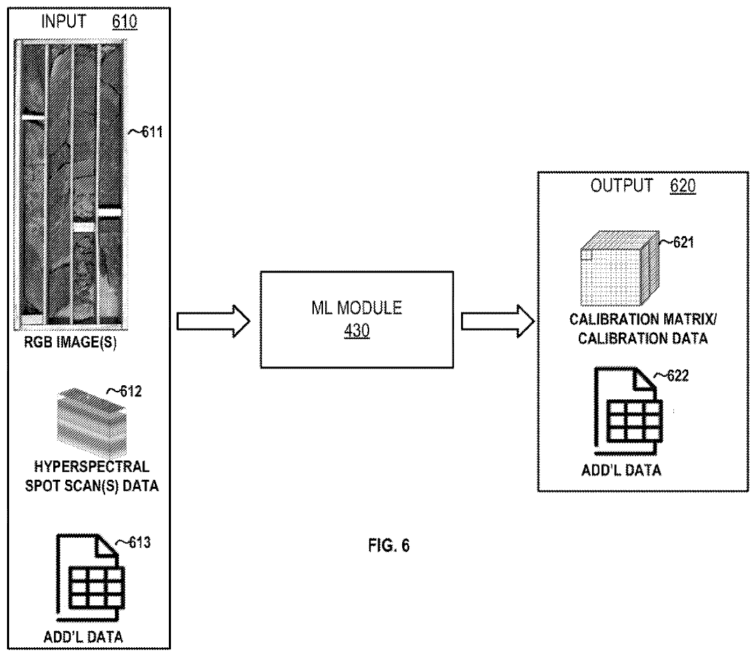

FIG. 6 shows example inputs 610 and outputs 620 of the ML module 430 once it has been trained. The ML module 430 may receive an RGB image(s) 611 of a sample and one or more hyperspectral “spot scans” and/or hyperspectral data (referred to herein as HS data 612) as the input 610. The RGB image(s) 611 may be aligned with the HS data 612. For example, the RGB image(s) 611 may be aligned with the HS data 612 as a result of being processed by the segmentation model described herein.

In some examples, the ML module 430 may receive additional data 613 as part of the input 610 as well. The additional data 613 may comprise the supplemental data described herein, such as orientation data, survey data, x-ray fluorescence (XRF) data, exclusion zone data, etc., associated with the sample. The ML module 430 may analyze the inputs 610 and produce the outputs 621. The outputs 621 may comprise a calibration matrix 621, such as one of the calibration matrices described herein that may be used to generate a false color mineral map. The outputs 621 may (optionally) comprise additional data 622. The additional data 622 may comprise a mineralogy report (e.g., indicating materials/minerals comprising the corresponding sample), a mineral map (e.g., indicating locations of the materials/minerals comprising the corresponding sample), an indication of an accuracy of the corresponding calibration matrix (e.g., a confidence level), a combination thereof, and/or the like.

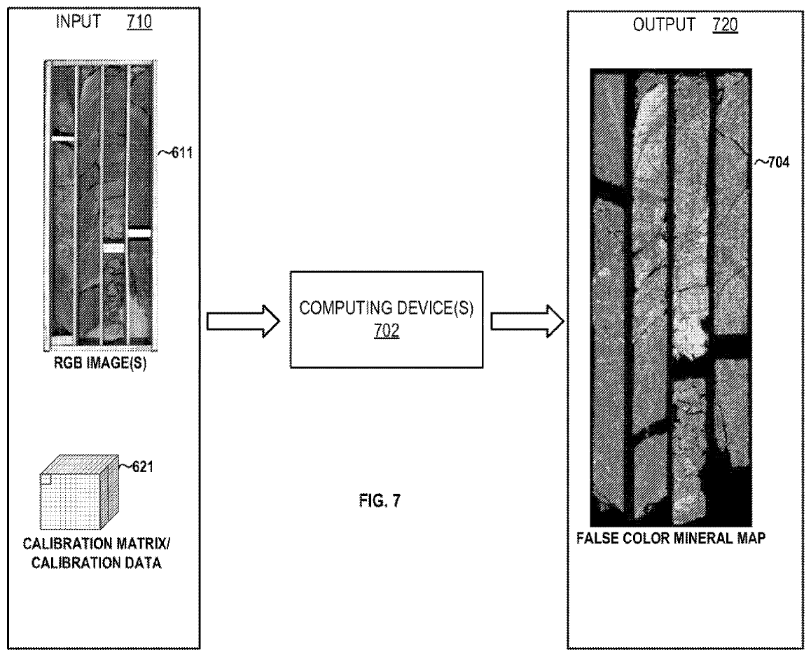

Turning now to FIG. 7, example inputs 710 and outputs 720 of a computing device 702 are shown. The computing device 702 may comprise the computing device 106 shown in FIG. 1 or any other computing device configured according to the methods and systems described herein. The computing device 702 may receive the RGB image(s) 611 and the calibration matrix 621 as the input 710. The computing device 702 may apply the calibration matrix 621 to the RGB image(s) 611 and generate the output 720, which may comprise a false color mineral map 704. The false color mineral map 704 may comprise, or be associated with, an indication of which mineral corresponds to which color shown in the false color mineral map 704. For example, the false color mineral map 704 may comprise, or be associated with, a color legend (not shown in FIG. 7) that provides such an indication (e.g., to associate each color shown in the false color mineral map 704 with the corresponding mineral). The color legend may be part of the output 720 generated by the computing device 702. For example, the output 720 generated by the computing device may include the color legend as a separate file, image, etc., and/or as a part of the false color mineral map 704 itself (e.g., as an annotation(s), metadata, etc.). The computing device 702 may send the output 720 (the false color mineral map 704 and the color legend) to another device(s) for storage, output, etc.

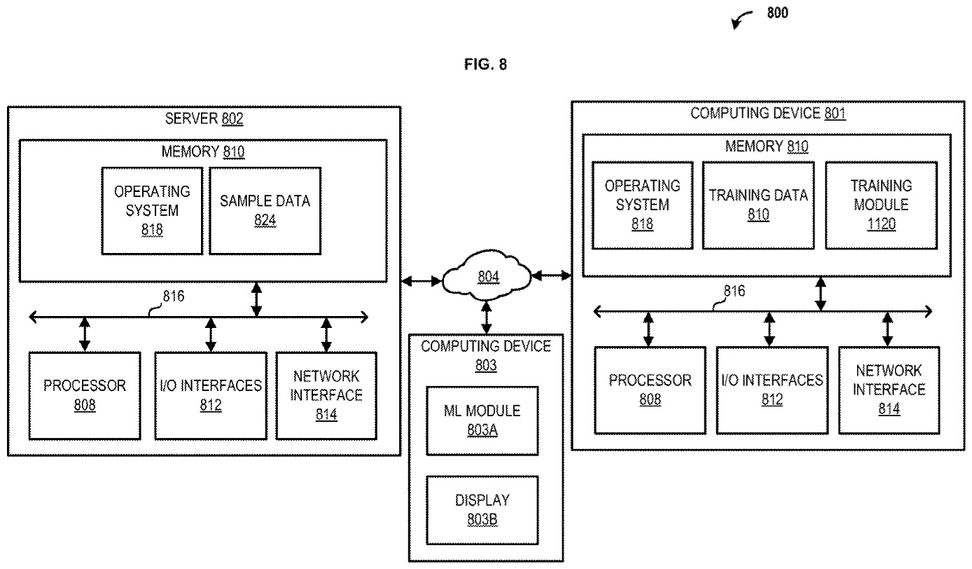

As discussed herein, the present methods and systems may be computer-implemented. FIG. 8 shows a block diagram depicting an environment 800 comprising non-limiting examples of a computing device 801 and a server 802 connected through a network 804. As an example, the server 104 and/or the computing device 106 of the system 100 may be a computing device 801 and/or a server 802 as described herein with respect to FIG. 8. In an aspect, some or all steps of any described method may be performed on a computing device as described herein. The computing device 801 can comprise one or multiple computers configured to store one or more of the training module 820, training data 810, and the like. The server 802 can comprise one or multiple computers configured to store sample data 824 (e.g., RGB and hyperspectral images of samples). Multiple servers 802 can communicate with the computing device 801 via the network 804.

The computing device 801 and the server 802 can be a digital computer that, in terms of hardware architecture, generally includes a processor 808, memory system 810, input/output (I/O) interfaces 812, and network interfaces 814. These components (1108, 810, 812, and 814) are communicatively coupled via a local interface 816. The local interface 816 can be, for example, but not limited to, one or more buses or other wired or wireless connections, as is known in the art. The local interface 816 can have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 808 can be a hardware device for executing software, particularly that stored in memory system 810. The processor 808 can be any custom made or commercially available processor, a central processing unit (CPU), an auxiliary processor among several processors associated with the computing device 801 and the server 802, a semiconductor-based microprocessor (in the form of a microchip or chip set), or generally any device for executing software instructions. When the computing device 801 and/or the server 802 is in operation, the processor 808 can be configured to execute software stored within the memory system 810, to communicate data to and from the memory system 810, and to generally control operations of the computing device 801 and the server 802 pursuant to the software.

The I/O interfaces 812 can be used to receive user input from, and/or for providing system output to, one or more devices or components. User input can be provided via, for example, a keyboard and/or a mouse. System output can be provided via a display device and a printer (not shown). I/O interfaces 812 can include, for example, a serial port, a parallel port, a Small Computer System Interface (SCSI), an infrared (IR) interface, a radio frequency (RF) interface, and/or a universal serial bus (USB) interface.

The network interface 814 can be used to transmit and receive from the computing device 801 and/or the server 802 on the network 804. The network interface 814 may include, for example, a 8BaseT Ethernet Adaptor, a 80BaseT Ethernet Adaptor, a LAN PHY Ethernet Adaptor, a Token Ring Adaptor, a wireless network adapter (e.g., WiFi, cellular, satellite), or any other suitable network interface device. The network interface 814 may include address, control, and/or data connections to enable appropriate communications on the network 804.

The memory system 810 can include any one or combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the memory system 810 may incorporate electronic, magnetic, optical, and/or other types of storage media. Note that the memory system 810 can have a distributed architecture, where various components are situated remote from one another, but can be accessed by the processor 808.

The software in memory system 810 may include one or more software programs, each of which comprises an ordered listing of executable instructions for implementing logical functions. In the example of FIG. 8, the software in the memory system 810 of the computing device 801 can comprise the training module 420 (or subcomponents thereof), the training dataset 410A, the training dataset 410B, and a suitable operating system (O/S) 818. In the example of FIG. 8, the software in the memory system 810 of the server 802 can comprise, the sample data 824, and a suitable operating system (O/S) 818. The operating system 818 essentially controls the execution of other computer programs and provides scheduling, input-output control, file and data management, memory management, and communication control and related services.

The environment 800 may further comprise a computing device 803. The computing device 803 may be a computing device and/or system, such as the server 104 and/or the computing device 106 of the system 100. The computing device 803 may use a model(s) stored in a Machine Learning (ML) module 803A to generate the false color mineral maps described herein. The computing device 803 may include a display 803B for presentation of a user interface.

For purposes of illustration, application programs and other executable program components such as the operating system 818 are illustrated herein as discrete blocks, although it is recognized that such programs and components can reside at various times in different storage components of the computing device 801 and/or the server 802. An implementation of the training module 420 can be stored on or transmitted across some form of computer readable media.

Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” can comprise volatile and non-volatile, removable and non-removable media implemented in any methods or technology for storage of information such as computer readable instructions, data structures, program modules, or other data. Exemplary computer storage media can comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

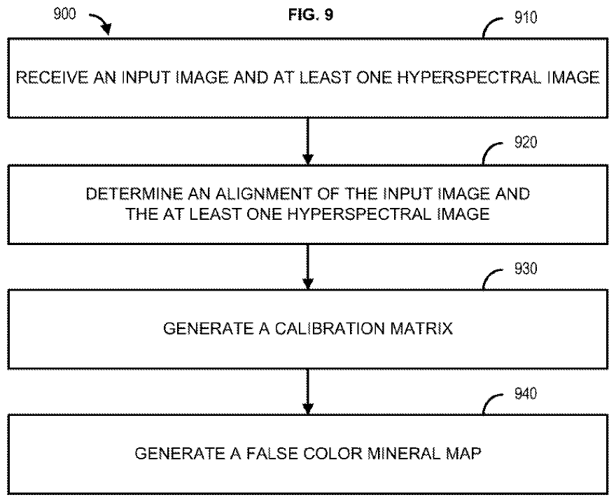

Turning now to FIG. 9, a flowchart of an example method 900 for improved sample imaging is shown. The method 900 may be performed in whole or in part by a single computing device, a plurality of computing devices, and the like. For example, the method 900 may be performed—in whole or in part—by any of the following devices: the server 104 and/or the computing device 106 of the system 100 or the server 802, the computing device 803, and/or the computing device 801 of the system 800.

At step 910, a computing device may receive an input image and at least one hyperspectral image. The input image may depict a sample. The input image may comprise a red-green-blue (RGB) two-dimensional image of the sample. The sample may comprise a plurality of minerals. The at least one hyperspectral image may depict a portion of the sample (e.g., a hyperspectral spot scan(s)). The computing device may also receive at least one of: x-ray fluorescence (XRF) data or exclusion zone data associated with the sample. The XRF data may be indicative of the plurality of minerals comprising the sample. The exclusion zone data may be indicative of at least one portion of the input image that is to be excluded from analysis.

At step 920, the computing device may use at least one machine learning model to determine an alignment of the input image and the at least one hyperspectral image. The at least one machine learning model may comprise a convolutional neural network (CNN). The CNN may be trained using a plurality of training input images and a plurality of training hyperspectral images. The plurality of training input images may depict a plurality of training samples that each comprise a plurality of minerals. Each training hyperspectral image of the plurality of training hyperspectral images may depict a portion of a respective training sample. The CNN may receive alignment data associated with the plurality of training input images and the plurality of training hyperspectral images. The CNN may also receive a plurality of false color mineral maps and a plurality of calibration matrices associated with the plurality of training samples. The CNN may be trained (e.g., per the method 500 described herein) based on: the plurality of training input images, the plurality of training hyperspectral images, the alignment data, the plurality of false color mineral maps, and the plurality of calibration matrices.

The at least one machine learning model may comprise a segmentation model. The segmentation model may determine the alignment of the input image and the at least one hyperspectral image by determining an orientation line associated with the sample. The segmentation model may determine the orientation line based on the input image and the at least one hyperspectral image. The segmentation model may also determine the orientation line based on supplemental data associated with the sample, such as orientation data, survey data, x-ray fluorescence (XRF) data, exclusion zone data, etc., associated with the sample.

At step 930, the computing device may use the at least one machine learning model to generate a calibration matrix. For example, the CNN, once trained, may be configured to output the calibration matrix based on the alignment of the input image and the at least one hyperspectral image. The calibration matrix may be associated with the sample and the RGB image of the sample. The at least one machine learning model may generate the calibration matrix based on: the alignment of the input image, the at least one hyperspectral image, and/or the supplemental data. The calibration matrix may be associated with at least one of: an imaging box, an imaging tray, or an excavation site associated with the sample.

At step 940, the computing device may generate a false color mineral map. For example, the computing device may generate the false color mineral map based on the calibration matrix and the input image. The false color mineral map may be indicative of the plurality of minerals associated with the samp. The false color mineral map may comprise a two-dimensional hyperspectral representation of the sample. The computing device may send the false color mineral map to another device(s) for storage, output, etc.

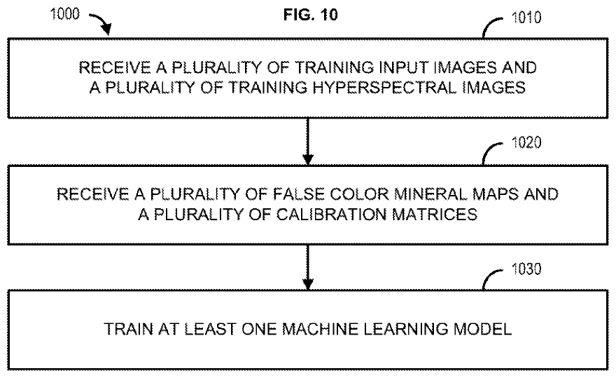

Turning now to FIG. 10, a flowchart of an example method 1000 for improved sample imaging is shown. The method 1000 may be performed in whole or in part by a single computing device, a plurality of computing devices, and the like. For example, the method 1000 may be performed—in whole or in part—by any of the following devices: the server 104 and/or the computing device 106 of the system 100 or the server 802, the computing device 803, and/or the computing device 801 of the system 800.

At step 1010, a computing device may receive an a plurality of training input images and a plurality of training hyperspectral images. The plurality of training input images may each depict a plurality of training samples. Each training hyperspectral image of the plurality of training hyperspectral images may depict a portion of a respective training sample of the plurality of training samples. Each training sample of the plurality of training samples may comprise one or more minerals of a plurality of minerals.

At step 1020, the computing device may receive a plurality of false color mineral maps and a plurality of calibration matrices. The plurality of false color mineral maps and the plurality of calibration matrices may be associated with the plurality of training samples. At step 1030, the computing device may train at least one machine learning model. For example, the at least one machine learning model may be trained based on one or more of: the plurality of training input images, the plurality of training hyperspectral images, the plurality of false color mineral maps, or the plurality of calibration matrices.

The at least one machine learning model, once trained, may be configured to generate a calibration matrix for an input image. For example, the at least one machine learning model may generate the calibration matrix based on a hyperspectral image corresponding to the input image. The input image may depict a sample comprising a plurality of minerals, and the hyperspectral image may depict a portion of the sample. For example, the input image may comprise a red-green-blue (RGB) two-dimensional image of the sample.

The at least one machine learning model may receive the input image and the hyperspectral image corresponding to the input image. The at least one machine learning model may determine an alignment of the input image and the at least one hyperspectral image. Based on the alignment of the input image and the hyperspectral image, the at least one machine learning model may generate the calibration matrix. The calibration matrix may be associated with at least one of: an imaging box associated with the sample, an imaging tray associated with the sample, or an indication of a spectral signature for at least one mineral of the plurality of minerals associated with the sample. Furthermore, based on the calibration matrix and the input image, the at least one machine learning model may generate a false color mineral map. The false color mineral map may be indicative of the plurality of minerals associated with the sample.

While specific configurations have been described, it is not intended that the scope be limited to the particular configurations set forth, as the configurations herein are intended in all respects to be possible configurations rather than restrictive. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect.

This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

1. A method comprising:
receiving, by a computing device, an input image and at least one hyperspectral image, wherein the input image depicts a sample comprising a plurality of minerals, and wherein the at least one hyperspectral image depicts a portion of the sample;
determining, by at least one machine learning model, an alignment of the input image and the at least one hyperspectral image;
generating, by the at least one machine learning model, based on the alignment of the input image and the at least one hyperspectral image, a calibration matrix; and
generating, based on the calibration matrix and the input image, a false color mineral map indicative of the plurality of minerals associated with the sample.

2. The method of claim 1, wherein the input image comprises a red-green-blue (RGB) two-dimensional image of the sample.

3. The method of claim 1, wherein the calibration matrix is associated with at least one of: an imaging box or an imaging tray associated with the sample.

4. The method of claim 1, wherein the calibration matrix is associated with an indication of a spectral signature for at least one mineral of the plurality of minerals associated with the sample.

5. The method of claim 1, wherein the false color mineral map comprises a two-dimensional hyperspectral representation of the sample.

6. The method of claim 1, wherein the at least one machine learning model comprises a convolutional neural network (CNN).

7. The method of claim 6, further comprising:
receiving, by the CNN, a plurality of training input images and a plurality of training hyperspectral images, wherein the plurality of training input images depict a plurality of training samples each comprising a plurality of minerals, and wherein each training hyperspectral image of the plurality of training hyperspectral images depicts a portion of a respective training sample;
receiving a plurality of false color mineral maps and a plurality of calibration matrices associated with the plurality of training samples; and
training the CNN based on: the plurality of training input images, the plurality of training hyperspectral images, the plurality of false color mineral maps, and the plurality of calibration matrices, wherein the CNN, once trained, is configured to output the calibration matrix based on the input image and the at least one hyperspectral image.

8. A method comprising:
receiving, by a computing device, a plurality of training input images and a plurality of training hyperspectral images;
receiving a plurality of false color mineral maps and a plurality of calibration matrices associated with the plurality of training samples; and
training at least one machine learning model based on: the plurality of training input images, the plurality of training hyperspectral images, the plurality of false color mineral maps, and the plurality of calibration matrices, wherein the at least one machine learning model, once trained, is configured to generate a calibration matrix for an input image of a sample, and wherein the calibration matrix is based on at least one hyperspectral image depicting a portion of the sample.

9. The method of claim 8, wherein the plurality of training input images depict a plurality of training samples each comprising a plurality of minerals.

10. The method of claim 9, wherein each training hyperspectral image of the plurality of training hyperspectral images depicts a portion of a respective training sample of the plurality of training samples.

11. The method of claim 8, further comprising:
receiving the input image of the sample and the at least one hyperspectral image depicting the portion of the sample; and
determining, by at least one machine learning model, an alignment of the input image and the at least one hyperspectral image.

12. The method of claim 11, further comprising:
generating, by the at least one machine learning model, based on the alignment of the input image and the at least one hyperspectral image, the calibration matrix; and
generating, based on the calibration matrix and the input image, a false color mineral map indicative of a plurality of minerals associated with the sample.

13. The method of claim 11, wherein the input image comprises a red-green-blue (RGB) two-dimensional image of the sample.

14. The method of claim 11, wherein the calibration matrix is associated with at least one of: an imaging box associated with the sample, an imaging tray associated with the sample, or an indication of a spectral signature for at least one mineral of the plurality of minerals associated with the sample.

15. An apparatus comprising:
one or more processors; and
computer-executable instructions that, when executed by the one or more processors, cause the apparatus to:
receive an input image and at least one hyperspectral image, wherein the input image depicts a sample comprising a plurality of minerals, and wherein the at least one hyperspectral image depicts a portion of the sample;
determine, via at least one machine learning model, an alignment of the input image and the at least one hyperspectral image;
generate, via the at least one machine learning model, based on the alignment of the input image and the at least one hyperspectral image, a calibration matrix; and
generate, based on the calibration matrix and the input image, a false color mineral map indicative of the plurality of minerals associated with the sample.

16. The apparatus of claim 15, wherein the input image comprises a red-green-blue (RGB) two-dimensional image of the sample.

17. The apparatus of claim 15, wherein the calibration matrix is associated with at least one of: an imaging box or an imaging tray associated with the sample.

18. The apparatus of claim 15, wherein the calibration matrix is associated with an indication of a spectral signature for at least one mineral of the plurality of minerals associated with the sample.

19. The apparatus of claim 15, wherein the false color mineral map comprises a two-dimensional hyperspectral representation of the sample.

20. The apparatus of claim 15, wherein the at least one machine learning model comprises a convolutional neural network (CNN).
